(19) United States
(12) Patent Application Publication
(10) Pub. No.: US 2024/0259178 A1
(43) Pub. Date: Aug. 1, 2024

(54) PERFORMING COMPARISON OPERATIONS UNDER HOMOMORPHIC ENCRYPTION

(71) Applicant: International Business Machines Corporation, Armonk, NY (US)

(72) Inventors: Nir DRUCKER, Zichron Yaakov (IL); Eyal KUSHNIR, Kfar Vradim (IL); Hayim SHAUL, Kfar Saba (IL)

(21) Appl. No.: 18/161,216

(22) Filed: Jan. 30, 2023

(51) Int. Cl. H04L 9/00; G06F 9/30

(52) U.S. Cl. CPC H04L 9/008; G06F 9/30021; G06F 9/30029

(57) ABSTRACT

An example system includes a processor to receive a circuit with a number of Boolean variables to be simulated over real numbers. The processor can encode the circuit using a negation-based encoding in response to detecting a chain of AND operations in the circuit. The processor can also execute the AND operations in the encoded circuit by summing negated variables. The processor can further reduce positive integers in results of the summed negated variables to a value of one. The processor can also further negate the results with reduced positive integers to generate decoded results of the AND operations.

### BACKGROUND

The present techniques relate to homomorphic encryption. More specifically, the techniques relate to performing operations under homomorphic encryption.

### SUMMARY

According to an embodiment described herein, a system can include processor to receive a circuit with a number of Boolean variables to be simulated over real numbers. The processor can also further encode the circuit using a negation-based encoding in response to detecting a chain of AND operations in the circuit. The processor can also execute the AND operations in the encoded circuit by summing negated variables. The processor can further reduce positive integers in the result of the summed negated variables to a value of one. The processor can then negate the results with reduced positive integers to generate decoded results of the AND operations. Thus, the system provides more efficient processing of circuits of AND operations on Boolean variables. In some embodiments, the circuit is encoded using a fuzzy AND gate. In these embodiments, the system enables approximate simulation of the circuit. In some embodiments, the positive integers in the results are reduced using a compare method. In these embodiments, the compare method provides an efficient method of processing the positive integers. In some embodiments, the positive integers in the results are reduced using an equality operator. In these embodiments, the equality operator provides an increasingly efficient method of processing the positive integers. In some embodiments, the processor is to analyze the circuit and identify a structure of ANDing the number of Boolean variables. In these embodiments, the identified structure provides a structure for encoding the circuit using the negation-based encoding. In various embodiments, summing the negative variables uses only addition operations. In these embodiments, the multiplication depth of the resulting circuit and processing efficiency is improved. In some embodiments, the AND operations are executed under homomorphic encryption. In these embodiments, the homomorphic encryption provides security for the data represented by the Boolean variables.

According to another embodiment described herein, a method can include receiving, via a processor, a circuit with a number of Boolean variables to be simulated over real numbers. The method can further include encoding, via the processor, the circuit using a negation-based encoding in response to detecting a chain of AND operations in the circuit. The method can also further include executing, via the processor, the AND operations in the encoded circuit by summing negated variables. The method can also include reducing, via the processor, positive integers in the result of the summed negated variables to a value of one. The method can further also include negating, via the processor, the results with reduced positive integers to generate decoded results of the AND operations. Thus, the method provides more efficient processing of circuits of AND operations on Boolean variables. In some embodiments, the method includes encoding the circuit using a fuzzy AND gate. In these embodiments, the method provides approximate simulation of the circuit. In some embodiments, reducing the positive integers includes using a compare method. In these embodiments, the compare method provides an efficient method of processing the positive integers. In some embodiments, the AND operations are executed under homomorphic encryption. In these embodiments, the method provides security for the data represented by the Boolean variables. In some embodiments, reducing the positive integers includes executing an equality operator. In these embodiments, the method provides an increasingly efficient method of processing the positive integers. In some embodiments, the method includes analyzing, via the processor, the circuit and identifying a structure of ANDing the number of Boolean variables. In these embodiments, the identified structure provides a structure for encoding the circuit using the negation-based encoding. In some embodiments, summing the negative variables includes only executing addition operations. In these embodiments, the method provides improved efficiency over methods that use multiplication operations.

According to another embodiment described herein, a computer program product for simulating circuits of Boolean variables can include computer-readable storage medium having program code embodied therewith. The program code executable by a processor to cause the processor to receive a circuit with a number of Boolean variables to be simulated over real numbers. The program code can also cause the processor to encode the circuit using a negation-based encoding in response to detecting a chain of AND operations in the circuit. The program code can also cause the processor to execute the AND operations in the encoded circuit by summing negated variables. The program code can also cause the processor to reduce positive integers in the result of the summed negated variables to a value of one. The program code can also cause the processor to negate the results with reduced positive integers to generate decoded results of the AND operations. Thus, the computer program product provides more efficient processing of circuits of AND operations on Boolean variables. In some embodiments, the program code can also cause the processor to also further encode the circuit using a fuzzy AND gate. In these embodiments, the program code provides approximate simulation of the circuit. In some embodiments, the program code can also cause the processor to also reduce the positive integers in the results using a compare method. In these embodiments, the compare method provides an efficient method of processing the positive integers. In some embodiments, the program code can also cause the processor to also execute an equality operator to reduce the positive integers. In these embodiments, the program code provides an increasingly efficient method of processing the positive integers. In some embodiments, the program code can also cause the processor to analyze the circuit and identify a structure of ANDing the number of Boolean variables. In these embodiments, the program code provides a structure for encoding the circuit using the negation-based encoding. In some embodiments, the program code can also cause the processor to sum the negative variables includes only executing addition operations. In these embodiments, the program code provides improved efficiency over methods that use multiplication operations.

### BRIEF DESCRIPTION OF THE SEVERAL VIEWS OF THE DRAWINGS

FIG. 1 is a block diagram of an example computing environment that contains an example of an environment for the execution of at least some of the computer code involved in performing the inventive methods, such as a homomorphic encryption (HE) comparison module;

FIG. 2 is an example tangible, non-transitory computer-readable medium that can execute encoding, aggregation, and comparison operations under HE;

FIG. 3 is a process flow diagram of an example method that can execute AND operations on Boolean circuits under HE;

FIG. 4 is a process flow diagram of an example method that can compare two numbers represented as binary representations under HE;

FIG. 5A is a block diagram of an example system for executing AND operations on Boolean circuits under HE; and

FIG. 5B is a block diagram of an example system for comparing two numbers represented as binary representations under HE.

### DETAILED DESCRIPTION

Some computational environments may support only a limited set of operations. For example, such operations may be limited to the execution of additions and multiplications of fixed-point or floating-point elements. As one example, approximate homomorphic encryption (HE) schemes, such as the approximate homomorphic encryption scheme of Cheon, Kim, Kim and Song (CKKS). Homomorphic encryption schemes are used to perform computations on encrypted data without first decrypting the data. Approximate homomorphic encryption schemes enable various complex operations to be approximated using the execution of addition and multiplication operations.

However, such approximate homomorphic encryption schemes may not be able to natively handle binary circuits. Rather, such schemes may use arithmetic computation to simulate Boolean operations. In particular, for Boolean variables x, y∈{0,1}, the following equations may be used to simulate specific Boolean operation. As one example, a Boolean AND operation ∧ may be simulated using the equation:

$$x ∧ y = x y \qquad Eq . 1$$

where the resulting simulated operation includes one multiplication operation. A Boolean OR operation ∨ may be simulated using the equation:

$$x ∨ y = x + y - x y \qquad Eq . 2$$

where the resulting simulated operation includes one multiplication operation and two addition operations. Similarly, a Boolean exclusive OR (XOR) operation ⊕ may be simulated using the equation:

$$x ⊕ y = {( x - y )}^{2} \qquad Eq . 3$$

where the resulting simulated operation includes one multiplication operation and one addition operation. The Boolean negation operation ¬ may be simulated using the equation:

$$¬ x = 1 - x \qquad Eq . 4$$

where the resulting simulated operation includes one addition operation. Except for the operation in Eq. 4, each operation requires at least one multiplication operation. The number of multiplication operations determines the multiplication depth, which defines the number of times that time-consuming bootstrapping that will be used. As used herein, bootstrapping refers to the process of refreshing a ciphertext in order to produce a new ciphertext that encrypts the same message, so that more homomorphic operations can be evaluated on the new ciphertext, as first proposed by Gentry in 2009. Because bootstrapping adds to overall latency, the overall latency of a system may thus be increased by the above simulations.

According to embodiments of the present disclosure, a system includes a processor that can receive a circuit with a number of Boolean variables to be simulated over real numbers. The processor can encode the circuit using a negation-based encoding in response to detecting a chain of AND operations in the circuit. The processor can execute the AND operations in the encoded circuit by summing negated variables. The processor can reduce positive integers in results of the summed negated variables to a value of one. The processor can negate the results with reduced positive integers to generate decoded results of the AND operation. In this manner, a sequence of Boolean AND operations may be efficiently evaluated. Thus, embodiments of the present disclosure enable more efficient simulation of a sequence of operations under HE. In particular, some embodiments enable reduction of the number of required multiplications when ANDing a large number of variables. In addition, some embodiments enable efficient comparison of two numbers represented using binary representation.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a homomorphic encryption (HE) encode, aggregate, and compare module 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

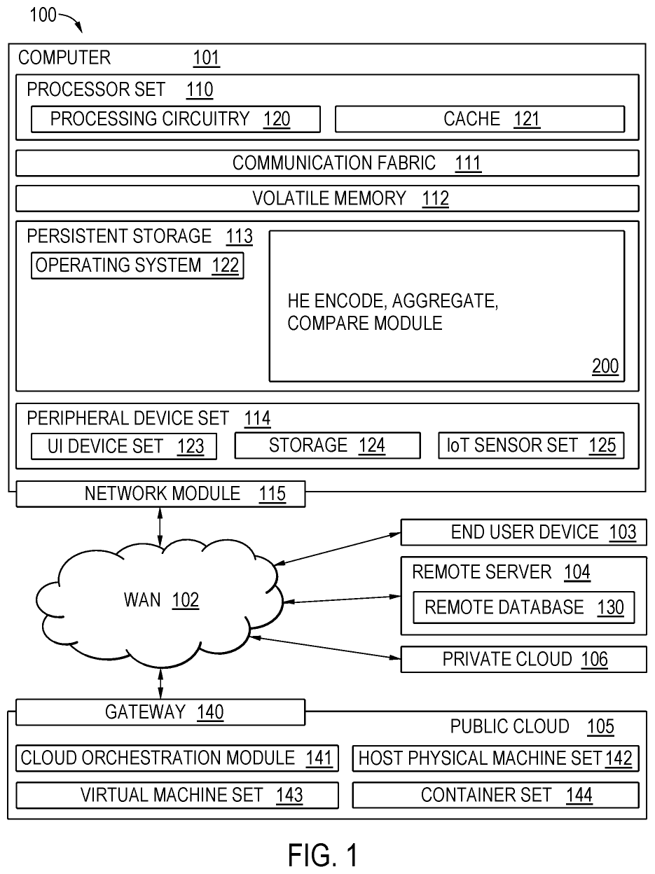

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

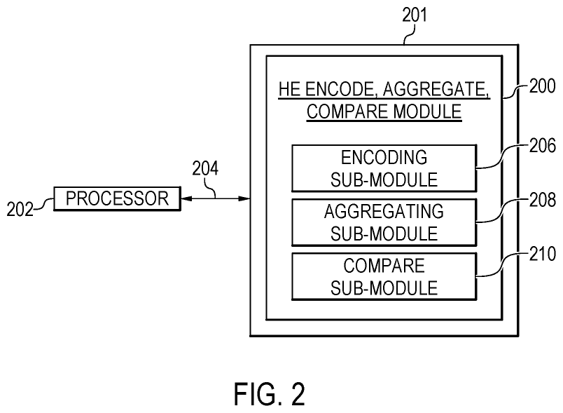

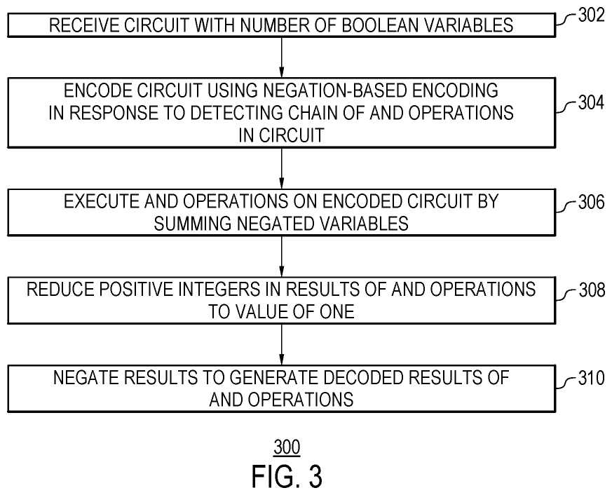

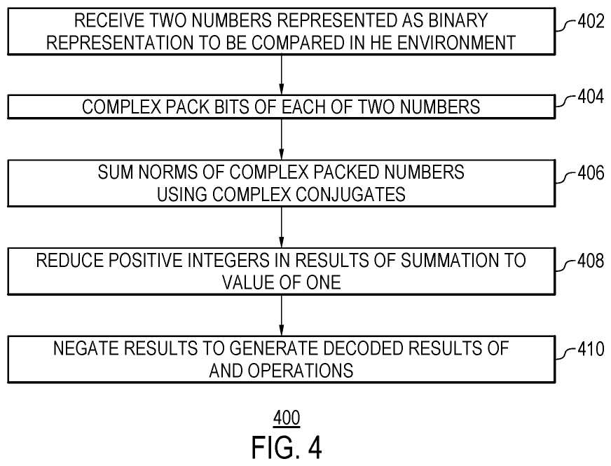

Referring now to FIG. 2, a block diagram is depicted of an example tangible, non-transitory computer-readable medium 201 that can execute encoding, aggregation, and comparison operations under HE. The tangible, non-transitory, computer-readable medium 201 may be accessed by a processor 202 over a computer interconnect 204. Furthermore, the tangible, non-transitory, computer-readable medium 201 may include code to direct the processor 202 to perform the operations of the methods 300 and 400 of FIGS. 3 and 4.

The various software components discussed herein may be stored on the tangible, non-transitory, computer-readable medium 201, as indicated in FIG. 2. For example, in some embodiments, the HE encode, aggregate, and compare module 200 includes an encoding sub-module 206 that includes code to receive a circuit with a number of Boolean variables to be simulated over real numbers. The encoding sub-module 206 includes code to encode the circuit using a negation-based encoding in response to detecting a chain of AND operations in the circuit. In some examples, the encoding sub-module 206 includes code to encode the circuit using a fuzzy AND gate. In some examples, the encoding sub-module 206 includes code to analyze the circuit and identify a structure of ANDing the number of Boolean variables. An aggregating sub-module 208 includes code to execute the AND operations in the encoded circuit by summing negated variables. The aggregating sub-module 208 further includes code to sum the negative variables includes only executing addition operations. A compare sub-module 210 includes code to reduce positive integers in the result of the summed negated variables to a value of one. In various examples, the compare sub-module 210 includes code to reduce the positive integers in the results using a compare method. In some examples, the compare sub-module 210 includes code to execute an equality operator to reduce the positive integers. The compare sub-module 210 also includes code to negate the results with reduced positive integers to generate decoded results of the AND operations.

In some embodiments, the encoding sub-module 206 includes code to receive two numbers represented as binary representations to be compared in a homomorphic encryption environment. In these embodiments, the encoding sub-module 206 includes code to complex pack the bits of each of the two numbers. For example, each sequential pair of bit values in each of the two numbers may be packed as pairs of real and complex numbers. In addition, the aggregating sub-module 208 includes code to sum the norms of the complex packed numbers using complex conjugates. In these embodiments, the compare sub-module 210 includes code to reduce positive integers in the results of summation to a value of one. The compare sub-module 210 further includes code to negate the reduced results to generate decoded results.

FIG. 3 is a process flow diagram of an example method that can execute AND operations on Boolean circuits under HE. The method 300 can be implemented with any suitable computing device, such as the computer 101 of FIG. 1. For example, the methods described below can be implemented by the processor set 110 of FIG. 1.

At block 302, a circuit with a number of Boolean variables to be simulated over real numbers is received. For example, the circuit may include any number of AND operations to be executed under homomorphic encryption (HE), such as fully homomorphic encryption (FHE).

At block 304, the circuit is encoded using a negation-based encoding in response to detecting a chain of AND operations in the circuit. In various examples, the circuit may be analyzed to identify a chain of many AND operations on a subset of variables. For example, the variables may be x₁, . . . , xₙ∈{0,1}. In some examples, the chain of AND operations may be organized into an AND tree. As one specific example, given an AND operation denoted by * and binary values a1, a2, a3, a4, a5, a6, a7, a8, the operation a1*a2*a3*a4*a5*a6*a7*a8 may typically be performed sequentially as: (((((((a1*a2)*a3)*a4)*a5)*a6)*a7)*a8). In other words, such a string of AND operations performed one at a time would result in seven sequential multiplications (AND)fuzzy so the multiplication depth be 7. However, because AND is a commutative operation, the operations may be arranged as:

((a1*a2)*(a3*a4))*((a5*a6)*(a7*a8)). In particular, at the first step, four parallel AND operations are computed between 4 pairs. At a second step, two operations are computed in parallel, and finally one addition multiplication is computed. This AND tree algorithm has the form of a (reverse) tree. The number of multiplication operations executed is still seven, but the multiplication depth is only three. Because the fuzzy AND gate described herein is also commutative, the fuzzy AND gate is compatible with such a tree-based algorithm. These variables may be negated to obtain a set of negated variables. For example, the set of negated variables may be x̅₁̅, x̅₂̅, . . . , x̅ₙ̅.

At block 306, AND operations in the encoded circuit are executed by summing negated variables. In various examples, the negated variables are summed using only addition operations. For example, the negated variables may be summed according to the equation:

$$s = {\sum }_{\{ i = 1 \}}^{n} \overline{{x}_{1}} \qquad Eq . 5$$

In various examples, the negated variables are summed together using a fuzzy AND gate in which only addition is performed.

At block 308, positive integers in the results of the summed negated variables are reduced to a value of one. In various examples, the results may be reduced to a value of one using a BLEACH method, first described in 2022 by Drucker et. al. For example, the BLEACH method may include by treating step functions as clean-up utilities and by leveraging the single instruction, multiple data (SIMD) capabilities of CKKS. In various examples, x can be normalized using BLEACH on

$$( \frac{x}{n} - \frac{1}{2 n} ) .$$

This has n/2 multiplications+number−multiplications in BLEACH˜log(n), where the naive method described above has n multiplications.

At block 310, the results are negated to generated decoded results of the AND operations. For example, values of one may be changed to zero, and values of zero may be changed to one. For example, the method 300 may thus return values according to the equation:

$$out = 1 ⇔ s = 0 \qquad Eq . 6$$

where the output is 0 when s is greater than or equal to 1. In various examples, an equality operator Eq(s,0) may be used. For example, the equality operator may compare s and 0 and return a Boolean result. For example, the equality operator may return a value of “true” if the values match or “false” if the values do not match. In the context of an approximated HE scheme such as CKKS, “true” or “false” values may include some noise. For example, a true value can be true plus some small noise. As one examples, if true is a value of one, then a true value may include the value 1.00000000123. Similarly, if false is a value of zero, then false may include the value of 0.0000000051. Thus, the total number of multiplications and the multiplication depth may depend only on the Eq( ) operation.

The process flow diagram of FIG. 3 is not intended to indicate that the operations of the method 300 are to be executed in any particular order, or that all of the operations of the method 300 are to be included in every case. Additionally, the method 300 can include any suitable number of additional operations. For example, the results of an AND sequence can be used as an indicator mask for lookup tables or decision trees.

FIG. 4 is a process flow diagram of an example method that can compare two numbers represented as binary representations under homomorphic encryption (HE). The method 400 can be implemented with any suitable computing device, such as the computer 101 of FIG. 1. For example, the methods described below can be implemented by the processor set 110 of FIG. 1.

At block 402, two numbers represented as binary representations to be compared in a homomorphic encryption environment are received. For example, the two numbers may be numbers a and b represented using the equations:

$$a = {\sum }_{\{ i = 0 \}}^{n} {a}_{i} {2}^{i} \qquad Eq . 7 A$$

$$b = {\sum }_{\{ i = 0 \}}^{n} {b}_{i} {2}^{i} \qquad Eq . 7 B$$

At block 404, the bits of each of the two numbers are complex packed. In various examples, each sequential pair of bit values in each of the two numbers may be packed as pairs of real and complex numbers. Each sequential pair of complex encoded bit values may thus be from the same number. For example, the bits of numbers a and b represented using the equations:

$${A}_{1} = ( {a}_{0} + i {a}_{1} ) , {A}_{2} = ( ( {a}_{2} + {ia}_{3} ) , … , {A}_{\frac{n}{2}} = ( {a}_{\frac{n - 1}{2}} + {ia}_{\frac{n}{2} - 1} ) \qquad Eq . 8 A$$

$${B}_{1} = ( {b}_{0} + i {b}_{1} ) , {B}_{2} = ( {b}_{2} + i {b}_{3} ) , … , {B}_{\frac{n}{2}} = ( {b}_{\frac{n - 1}{2}} + i {b}_{\frac{n}{2} - 1} ) \qquad Eq . 8 B$$

At block 406, norms of the complex packed numbers are summed using complex conjugates. For example, the complex bits comparator dⱼ may be denoted using the equation:

$${d}_{j} = ( {a}_{2 j} + i {a}_{2 j + 1} ) - ( {b}_{2 j} + i {b}_{2 j + 1} ) = ( {a}_{2 j} - {b}_{2 j} ) + i ( {a}_{2 j + 1} - {b}_{2 j + 1} ) , for 0 \leq j \leq \frac{n - 1}{2} \qquad Eq . 9$$

In addition, a sum of inequalities D may then be defined using the equation:

$$0 \leq D = \sum ( {d}_{j} * {\overline{d}}_{j} ) = \sum {‖ {d}_{j} ‖}^{2} \leq n \qquad Eq . 10$$

where every element of the sum of inequalities D indicates whether two compared bits are equal (value 0) or unequal (value one of +/−1, +/−I, +/−1+/−i). Thus, D is basically an integer indicator. In particular, if D is 0, then all comparisons were successful and thus all 0. By contrast, if at least one compare failed, then the sum D is more than 0.

At block 408, positive integers in the results of summation are reduced to a value of one. For example, the positive integers may be similarly reduced using the BLEACH method as described in FIG. 3.

At block 410, the reduced results are negated to generate decoded results. In various examples, values of one may be changed to zero, and values of zero may be changed to one. For example, the reduced results may be negated using the simulated operation of Eq. 4 above. The negated results may then be returned. For example, the returned results may be the output of 1-Eq(D, 0).

The process flow diagram of FIG. 4 is not intended to indicate that the operations of the method 400 are to be executed in any particular order, or that all of the operations of the method 400 are to be included in every case. Additionally, the method 400 can include any suitable number of additional operations.

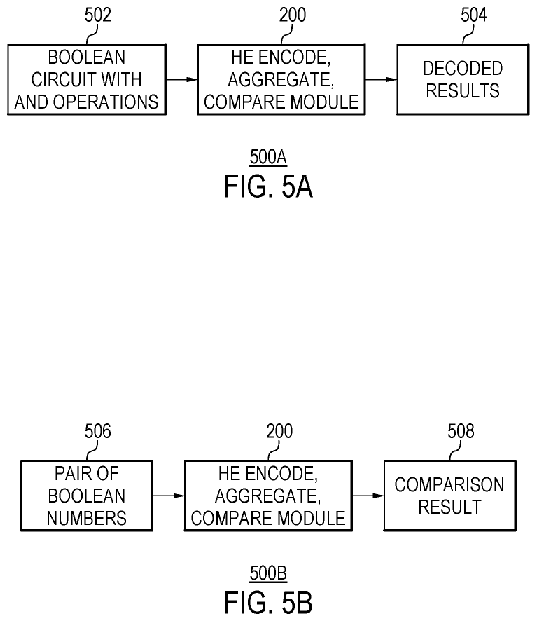

With reference now to FIG. 5A, a block diagram shows an example system for executing AND operations on Boolean circuits under HE. The example system is generally referred to by the reference number 500A. FIG. 5A includes similarly referenced elements from FIG. 1. In particular, the HE encode, aggregate, and compare module 200 is shown receiving a Boolean circuit with AND operations 502 and generating decoded results 504. As one example, let x₁, x₂, . . . . xₙ be n Boolean variables. In this example, an example received Boolean circuit 502 may be described via the equation:

$$C = AND\_ {\{ i = 1 \}}^{∧} \{ n \} \{ {x}_{i} \} \qquad Eq . 11$$

where the circuit C outputs the AND value of all the x₁, . . . , xₙ variables. Such a circuit C may usually implemented by using a balanced binary tree and requires n multiplications with a resulting multiplication depth of log(n). However, according to embodiments herein, a encoding method Encode(x)=not(x)=1−x receives a Boolean value and returns its negation. Advantageously, this operation is free when using modern HE schemes. In particular, such operation may not use any additional significant computational resources. In addition, a fuzzy AND gate may be used. For example, the fuzzy AND gate may be defined by the equation:

$$fuzzy - AND ( x , y ) = x + y \qquad Eq . 12$$

where the fuzzy AND gate can receive as input two Boolean values x and y. For example, x and y may be represented using values in Z. In some examples, x and y may be represented in R+ when dealing with floating point elements. The fuzzy AND gate may then output one value in the same range. In various examples, circuit C may be constructed using Encode( ) and fuzzy AND gates. For example, circuit C may be constructed according to the equation:

$$C = Decode ( Eq ( 0 , Fuzzy - AND\_ {\{ i = 0 \}}^{∧} \{ n \} \{ Encode ( {x}_{i} ) \} ) ) \qquad Eq . 13$$

where Eq( ) is an equality function over homomorphic encryption (HE). In particular, an AND(x,y) operation returns one only when both x and y are 1. Alternatively, it returns 0 if at least one of x,y is 0. In contrast, the Fuzzy—AND (x,y) gate returns 0 only if both x and y are 0, and returns a positive integer if x, y, or both are positive. Consequently, the Fuzzy—AND gate operates similarly to AND on the negation of the AND inputs. The only difference is that its output can be any positive integer, which is reduced back to a value of 1 by using the equality function Eq( ) This function checks whether the final result is 0 or any other positive integer in the range [1, . . . , n].

In various examples, the results are decoded by negating them. As the Fuzzy-AND gate only involves additions, the Fuzzy-AND gate therefore has no costs in the HE domain. The number of multiplications and the multiplication depth required are instead directly derived from the compare operator. Moreover, the compare operator is increasingly more efficient than alternatives when n is larger, thus resulting in more efficient use of processing resources.

It is to be understood that the block diagram of FIG. 5A is not intended to indicate that the system 500A is to include all of the components shown in FIG. 5A. Rather, the system 500A can include fewer or additional components not illustrated in FIG. 5A (e.g., additional circuits, or additional decoded results, etc.).

With reference now to FIG. 5B, a block diagram shows an example system for comparing two numbers represented as binary representations under HE. The example system is generally referred to by the reference number 500B. FIG. 5B includes similarly referenced elements from FIG. 1. In the example of FIG. 5B, the HE encode, aggregate, and compare module 200 is shown receiving a pair of Boolean numbers 506 and generating a comparison result 508.

In the example of FIG. 5B, two Boolean numbers 506 represented using binary digits are compared efficiently using a complex packing. For example, half of the binary digits of each of the numbers may be encoded using imaginary numbers via any suitable scheme, such as CKKS, that supports complex numbers. The complex packing may thus be used to reduced the number of operations performed by half. In various examples, the two Boolean numbers 506 may be compared using the method 400 of FIG. 4 to generate comparison result 508.

It is to be understood that the block diagram of FIG. 5B is not intended to indicate that the system 500B is to include all of the components shown in FIG. 5B. Rather, the system 500B can include fewer or additional components not illustrated in FIG. 5B (e.g., additional pairs of Boolean numbers, or additional comparison results, etc.).

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising a processor to:
receive a circuit with a plurality of Boolean variables to be simulated over real numbers;
encode the circuit using a negation-based encoding in response to detecting a chain of AND operations in the circuit;
execute the AND operations in the encoded circuit by summing negated variables;
reduce positive integers in results of the summed negated variables to a value of one; and
negate the results with reduced positive integers to generate decoded results of the AND operations.

2. The system of claim 1, wherein the circuit is encoded using a fuzzy AND gate.

3. The system of claim 1, wherein the positive integers in the results are reduced using a compare method.

4. The system of claim 1, wherein the positive integers in the results are reduced using an equality operator.

5. The system of claim 1, wherein the processor is to analyze the circuit and identify a structure of ANDing the plurality of Boolean variables.

6. The system of claim 1, wherein summing the negative variables uses only addition operations.

7. The system of claim 1, wherein the AND operations are executed under homomorphic encryption.

8. A computer-implemented method, comprising:
receiving, via a processor, a circuit with a plurality of Boolean variables to be simulated over real numbers;
encoding, via the processor, the circuit using a negation-based encoding in response to detecting a chain of AND operations in the circuit;
executing, via the processor, the AND operations in the encoded circuit by summing negated variables;
reducing, via the processor, positive integers in results of the summed negated variables to a value of one; and
negating, via the processor, the results with reduced positive integers to generate decoded results of the AND operations.

9. The computer-implemented method of claim 8, further comprising encoding the circuit using a fuzzy AND gate.

10. The computer-implemented method of claim 8, wherein reducing the positive integers comprises using a compare method.

11. The computer-implemented method of claim 8, wherein the AND operations are executed under homomorphic encryption.

12. The computer-implemented method of claim 8, wherein reducing the positive integers comprises executing an equality operator.

13. The computer-implemented method of claim 8, comprising analyzing, via the processor, the circuit and identifying a structure of ANDing the plurality of Boolean variables.

14. The computer-implemented method of claim 8, wherein summing the negative variables comprises only executing addition operations.

15. A computer program product for simulating circuits of Boolean variables, the computer program product comprising a computer-readable storage medium having program code embodied therewith, the program code executable by a processor to cause the processor to:
receive a circuit with a plurality of Boolean variables to be simulated over real numbers;
encode the circuit using a negation-based encoding in response to detecting a chain of AND operations in the circuit;
execute the AND operations in the encoded circuit by summing negated variables;
reduce positive integers in results of the summed negated variables to a value of one; and
negate the results with reduced positive integers to generate decoded results of the AND operations.

16. The computer program product of claim 15, further comprising program code executable by the processor to encode the circuit using a fuzzy AND gate.

17. The computer program product of claim 15, further comprising program code executable by the processor to reduce the positive integers in the results using a compare method.

18. The computer program product of claim 15, further comprising program code executable by the processor to execute an equality operator to reduce the positive integers.

19. The computer program product of claim 15, further comprising program code executable by the processor to analyze the circuit and identify a structure of ANDing the plurality of Boolean variables.

20. The computer program product of claim 15, further comprising program code executable by the processor to sum the negative variables comprises only executing addition operations.
